(19) United States
(12) Patent Application Publication
(10) Pub. No.: US 2009/0050253 A1
(43) Pub. Date: Feb. 26, 2009

(54) Reprocess Indicating Device

(75) Inventors: Matthew D. Thomas, New Freedom, PA (US); Dean Hill, New Freedom, PA (US)

Correspondence Address: ECKERT SEAMANS CHERIN & MELLOTT, 600 GRANT STREET, 44TH FLOOR, PITTSBURGH, PA, 15219, US

(73) Assignee: OPSEC SECURITY GROUP, INC., Denver, CO (US)

(21) Appl. No.: 12/196,366

(22) Filed: Aug. 22, 2008

Related U.S. Application Data
(60) Provisional application No. 60/957,572, filed on Aug. 23, 2007.

(51) Int. Cl. B32B 37/14; B32B 7/14; B32B 1/02

(52) U.S. Cl. 156/64; 428/203; 428/34.1

(57) ABSTRACT

The present invention provides a secure indicator label device for use on an article or container which includes a visual indicator, tamper-evident and/or anti-counterfeit features. Also provided are methods for indicating whether an article or the contents of a container have been exposed to a particular environment and a method for reducing the likelihood of improper re-use of a single-use article or container.

This patent application claims priority to Provisional Patent Application 60/957,572, filed on Aug. 23, 2007.

### BACKGROUND OF THE INVENTION

1. Field of the Invention

The present invention relates generally to security devices and, more particularly, to secure indicator labels that provide users with a visual warning or affirmation that an article to which the label is attached has been exposed to a particular environment.

2. Description of the Prior Art

There are many laboratory, medical, pharmaceutical and industrial situations where it is useful to know whether a particular article or material has been exposed to a particular environment. In some cases, this is because the article or material loses effectiveness if it has been exposed to a particular environment, for example, moisture, heat, or certain chemicals. In other cases, it is because the user simply wants to know whether the article is sterile or has been previously wet or washed. As an example, the properties of many materials change as their moisture content changes. A chemist, for example, may wish to know whether a particular bottle of a chemical is “fresh,” i.e. has not been contaminated by water.

Medical devices designed for multiple-use typically are expensive to acquire and to maintain, particularly those with small lumens and intricate, delicate working mechanisms which are difficult to properly sterilize or clean. Thus, single-use disposable medical devices have become popular alternatives. Hospitals generally welcome the convenience of such single-use disposable products because of reduced concerns with product age, preparation, pre-testing, overuse, breakage, malfunction and sterilization. However, with the advent of single-use medical devices, there is an economic incentive among some users of these devices to attempt to clean and re-use such single-use medical devices.

One way to determine that a medical device has never been used before is to receive it from the manufacturer in its original, unopened and sealed packaging. However, in most hospitals, medical devices are prepped by nurses or assistants and the physician or surgeon never has an opportunity to see the medical devices in their original, sterile packaging.

Another way to determine that a device, such as a medical device, has never been used before is through the placement of labels, stickers or tapes on the device or packaging. The labels, stickers or tapes may contain a chemical indicator that changes color, for example, when exposed to an undesirable environment. However, labels, stickers and tapes can be tampered with or replaced with new look-alikes in an attempt to pass off a used device as an unused one.

U.S. Patent Application No. 2006/0054526 discloses a medical device wherein a color-changing indicator is added to the plastic resin during manufacture. When exposed to a specific environment, the plastic resin changes color. Besides the disadvantage of cost, however, this method can be defeated simply by painting the color-changed plastic parts to the original, un-indicated color so that the medical device appears unused.

U.S. Patent Application No. 2006/0069305 discloses a medical device that is wrapped in a hydrophilic cover that contains a color-changing indicator. When the cover is exposed to an undesirable environment, it changes color to alert the user. A “colored” cover, however, easily can be removed and replaced with a new cover. Thus, this method does not protect-well against reprocessing and reuse.

Thus, there exists a need for an inexpensive, accurate indicator method to identify exposure to a particular environment for devices, including but not limited to single-use devices and medical devices, which is visually apparent and tamper-evident.

### SUMMARY OF THE INVENTION

The present invention meets this need by providing a label device for use on an article which improves on the prior art by including not only a visual indicator wherein the indicator is capable of undergoing a color change when exposed to a particular environment, but tamper-evident and/or anti-counterfeit features as well.

In an aspect of the present invention, there is provided a secure indicator label device for use on an article or container by including a visual indicator that is tamper-evident.

In another aspect of the present invention, there is provided a secure indicator label device for use on an article or container by including a visual indicator that is tamper-evident and contains anti-counterfeit features.

In another aspect of the present invention, there is provided a secure indicator label device for an article or container, comprising a multi-layer label with a transparent top layer, a visually-indicating middle layer and an adhesive bottom layer.

In another aspect of the present invention, there is provided a secure indicator label device for an article or container, comprising a multi-layer label with a transparent top layer, a visually-indicating middle layer and an adhesive bottom layer, in which a mask is placed between the transparent top layer and the indicator layer. In this aspect, the mask message is readable from the transparent layer side. The label also includes an anti-counterfeit feature and an anti-tampering feature which can be applied to various locations on the device or container. Depending on the form and function of the article or container, the label can be applied to a solid surface or across a seam where mating parts have been assembled. This aspect of the invention is suitable for application of the label to the outside of an article.

In another aspect of the present invention, there is provided a secure indicator label device for an article or container, comprising a multi-layer label with a transparent top layer, a visually-indicating middle layer and an adhesive bottom layer, in which a mask is placed between the indicator layer and the adhesive layer. In this aspect, the mask message is readable from the adhesive side. Also, in this aspect of the invention as well, the label includes an anti-counterfeit feature and an anti-tampering feature which can be applied to various locations on the device or container. Depending on the form and function of the device or container, the label can be applied to a solid surface or across a seam where mating parts have been assembled. This aspect of the invention is suitable for application to the inside of a transparent container such as a glass bottle or jar.

In another aspect of the present invention, there is provided a secure indicator label device for an article or container, in which the secure indicator label device is part of the construction of the article or container.

In another aspect of the present invention, there is provided a method for indicating whether an article or the contents of a container have been exposed to a particular environment.

In another aspect of the present invention, there is provided a method for reducing the likelihood of improper re-use of a single-use article or container. In an embodiment, the single-use article or container is a single-use medical article or container.

The visual indicator can be any material that provides a visual cue that corresponds to a change in the environment. Typically, such indicators are chemicals or dyes that change color when in the presence of a particular environmental condition. The environmental change can be, for example, a change in moisture, humidity, temperature, pressure, pH, or the presence of a particular chemical. Thus, an end-user would be able to tell that an article to which the indicator label is affixed had been exposed to water, heat, solvents and the like. Such indicators are well-known in the art and typically are available commercially as substrates of paper or another material that have been impregnated with a microencapsulated dye. It can be readily appreciated by those skilled in the art that any visual indicator for any environmental change can be incorporated into the indicator label.

The tamper-evident feature is any one of a number of features that effectively prevents the label from being removed intact from the article and later replaced thereon. Such tamper-evident features are well-known in the art and include, for example, die cuts in the label that cause the label to segment if attempts are made to peel the label off the article. In a particular embodiment of the invention, the tamper-evident feature is created by the incorporation of a pattern of release material between layers of the label, wherein such material selectively degrades the chemical bond between the layers such that the label is destroyed if an attempt is made to remove the label from the article.

The anti-counterfeiting feature is a visual device that is difficult to reproduce and includes an optically variable device or combinations of optical devices. Specifically, when the label is observed from a predetermined first relative observation point, the label is clearly visible and the at least one optically variable device provides at least a first optical effect. When the label is observed from a predetermined second relative observation point, the at least one optically variable device provides at least a second optical effect. At least one of the number of optical elements may be a holographic element.

The advantages of the invention and its previously uncombined elements of indication, anti-counterfeiting and tamper-evidence, are its security, low cost and ease of use.

Accordingly, it is an object of the present invention to provide a device and method to ensure that single-use articles and containers, such as those used in the medical field, are not used more than one time.

It is another object of the present invention to provide a device and method for the user to ascertain whether the single-use articles or containers they are preparing to use are new or whether they have been used previously. For example, to provide a device and method for physicians, surgeons and other medical practitioners to ascertain whether the single-use medical articles or containers they are preparing to use are new or whether they have been used previously.

### BRIEF DESCRIPTION OF THE DRAWINGS

A full understanding of the invention can be gained from the following description of the preferred embodiments when read in conjunction with the accompanying drawings in which:

FIG. 1 shows a side view of a secure indicator label in accordance with this invention;

FIG. 2 shows a top view of a secure indicator label in accordance with this invention;

FIG. 3 shows a side view of a secure indicator label in accordance with this invention;

FIG. 4 shows a side view of a secure indicator label in accordance with this invention; and

FIG. 5 shows a flow chart of a method for reducing the likelihood of improper re-use of a single-use medical device in accordance with this invention.

### DESCRIPTION OF THE PREFERRED EMBODIMENTS

The present invention provides a secure indicator label device for use on an article or container by including not only a visual indicator capable of undergoing a color change when exposed to a particular environment, but tamper-evident and/or anti-counterfeit features as well. In an aspect of the present invention, the article or container is a single-use article or container. In another aspect, the article or container is a medical article or container, such as a single-use medical article or container.

In an embodiment of the present invention, there is provided a secure indicator label device for use on an article or container by including a visual indicator that is tamper-evident.

In another embodiment of the present invention, there is provided a secure indicator label device for use on an article or container by including a visual indicator that is tamper-evident and contains anti-counterfeit features.

In another embodiment of the present invention, there is provided a secure indicator label device for an article or container, comprising a multi-layer label with a transparent top layer, a visually-indicating middle layer and an adhesive bottom layer.

In another embodiment of the present invention, there is provided a secure indicator label device for an article or container, comprising a multi-layer label with a transparent top layer, a visually-indicating middle layer and an adhesive bottom layer, in which a mask is placed between the transparent top layer and the indicator layer. In this aspect, the mask message is readable from the transparent layer side. The label also includes an anti-counterfeit feature and an anti-tampering feature which can be applied to various locations on the device or container. Depending on the form and function of the device or container, the label can be applied to a solid surface or across a seam where mating parts have been assembled. This aspect of the invention is suitable for application of the label to the outside of an article. In a further embodiment, the label is applied to the outside of a single-use medical article.

In another embodiment of the present invention, there is provided a secure indicator label device for a single-use article or container, comprising a multi-layer label with a transparent top layer, a visually-indicating middle layer and an adhesive bottom layer, in which a mask is placed between the indicator layer and the adhesive layer. In this aspect, the mask message is readable from the adhesive side. Also in this aspect of the invention as well, the label includes an anti-counterfeit feature and an anti-tampering feature which can be applied to various locations on the device or container. Depending on the form and function of the device or container, the label can be applied to a solid surface or across a seam where mating parts have been assembled. This aspect of the invention is suitable for application to the inside of a transparent container such as a glass bottle or jar.

In another embodiment of the present invention, there is provided a secure indicator label device for an article or container, in which the secure indicator label device is part of the construction of the article or container.

In another embodiment of the present invention, there is provided a method for indicating whether an article or the contents of a container have been exposed to a particular environment.

In another embodiment of the present invention, there is provided a method for reducing the likelihood of improper re-use of a single-use article or container. In another aspect, the article or container is a single-use article or container; and in other aspects, the article or container is a medical article or container or a single-use medical article or container.

A complete understanding of the present invention will be obtained from the following description taken in connection with the accompanying drawing figures, wherein like reference characters identify like parts throughout.

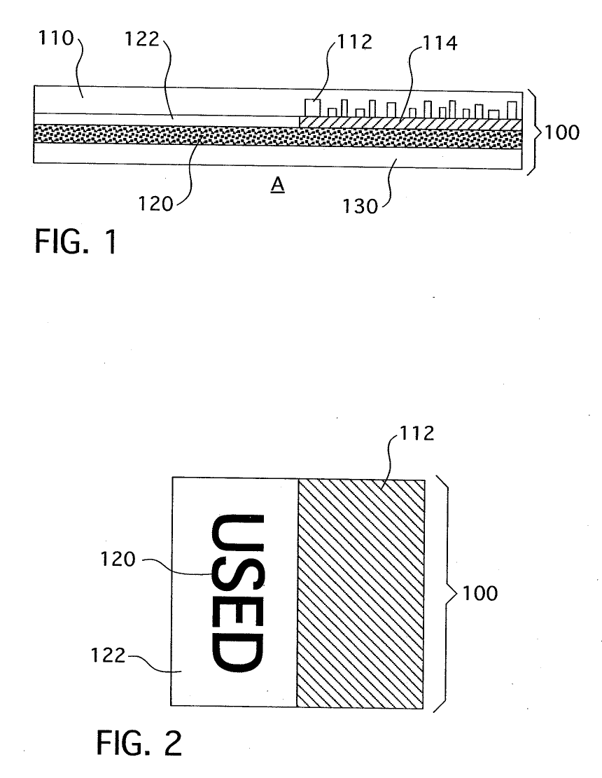

Referring to FIG. 1 of the drawings, there is shown in side view an embodiment of the invention that includes an anti-counterfeit feature and a mask. FIG. 1 shows a multi-layer label 100, which comprises a top layer 110, a bottom layer 120, and an adhesive layer 130. A top view of the same embodiment is shown in FIG. 2. The top layer 110 is a transparent polymeric film that includes an anti-counterfeiting feature 112. This layer serves to firmly attach underlying layers to the article. It also acts as a protective barrier for all other layers. An anti-counterfeiting feature or features, such as holograms or other optically variable devices 112, are embossed into the under side of the transparent polymeric film 110, and a thin coating of reflective material 114, typically aluminum, is applied to the optically variable device 112. The reflective material 114 is necessary to create the proper optical properties in the optically variable device 112. Such features discourage defeat by removing the label and replacing it with a look-alike counterfeit label because optically variable devices are difficult to copy; indeed they cannot be copied by traditional photocopy and printing techniques.

The label also includes a bottom layer 120 of material that changes color when exposed to a particular environment, for example, when it comes into contact with water, steam, heat or a particular chemical. Such materials are available commercially and generally comprise an absorbent paper substrate impregnated with an indicator chemical or dye that changes color when exposed to the triggering environment. A mask 122 is included between the transparent polymeric film 110 and the indicator material 120. Finally, a layer of adhesive 130 glues the label to the article A.

The mask 122 is an opaque ink layer that is color-matched to the indicator material 120 before the color change of the indicator material 120 is triggered. The mask 122 can be printed either on the bottom surface of the film 110 or on the top surface of the indicator material 120. The mask 122 is printed in a design that leaves unprinted text characters and shapes that comprise a message to the end user. When the indicator material 120 has not been exposed to its triggering environment, it is the same color as the mask 122 and the message cannot be seen. But when the indicator material 120 has been exposed, it changes to a contrasting color that shows through the unprinted areas on the mask 122, revealing the message.

A tamper-evident feature is a design or construction feature that guards against defeat of a label by removing the label from the article before reprocessing and replacing the same label afterwards. Such tamper-evident features are well-known in the art and include, for example, die cuts in the label that cause the label to segment if attempts are made to peel the label off the article.

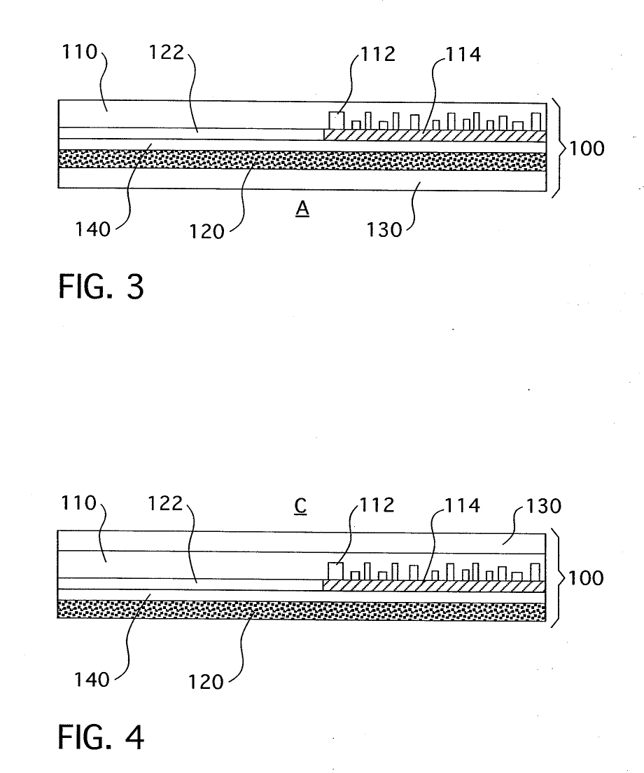

FIG. 3 shows a side view of an embodiment of the invention that includes an anti-counterfeit feature, a tamper-evident feature and a mask. In FIG. 3, there is incorporated another kind of tamper-evident feature, selective ply-bond degradation.

This embodiment is identical to the embodiment shown in FIGS. 1 and 2, with the addition of an additional layer 140 that comprises the tamper-evident feature. The tamper-evident feature is created by the incorporation of a pattern of release material 140 printed or deposited between the bottom layer of indicator material 120 and the reflective material 114 and mask 122. Where deposited, the release material 140 degrades the chemical bond between the bottom indicator layers 140 and the reflective material 114 and mask 122. The chemical bond between the layers is weakened in the areas corresponding to the pattern of the release material 140. If an attempt is made to remove the label 100 from article A, the label 100 will delaminate at the areas of weakest inter-ply bond, that is, in the area where the release material 140 has been deposited. In these areas, the reflective material 114 and mask 122 will be pulled off with the top film layer 110; in the areas where no release material 140 has been deposited the inter-ply bond is not degraded, and the reflective material 114 and mask 122 will remain bonded to the indicator material 120. Thus, the integrity of the reflective material 114 and the mask 122 will be destroyed and the label 100 will not be available for re-use.

In a particular embodiment of the invention, article A is a single-use medical device and the indicator material 120 is sensitive to water. When the single-use medical device is new and unused, no message is apparent to the physician or surgeon since the color of the mask 122 is the same as the color of the unexposed indicator material 120. However, once the single-use medical device is exposed to moisture, either from use or from reprocessing after use, the indicator material 120 changes color, revealing a message that permanently indicates that the instrument has been used. Placement of the mask below the anti-counterfeiting feature 112 guards against defeat by a re-processor that brushes over the message with a paint or ink color that matches the mask color. Doing so would cover the anti-counterfeiting feature 112 and be visually obvious. Inclusion of the tamper-evident feature 140 guards against defeat by a re-processor that removes the label before processing and replaces it afterwards. Attempts to remove the label will damage it and be visually obvious.

FIG. 4 of the drawings illustrates another embodiment of the invention useful in situations where the label is applied to the inside of a transparent container and the user's point-of-view is from the adhesive side of the label. FIG. 4 shows a side view of a multi-layer label 100, which comprises a top layer 110, a bottom layer 120, and an adhesive layer 130. The label shown in FIG. 4 is identical to the label shown in FIG. 3, except the adhesive layer 130 is applied to the top layer 110 rather than the bottom layer 120. This placement of the adhesive layer 130 allows the label 100 to be affixed to the inside of a transparent container C.

In a particular embodiment, the container C is a glass bottle for the storage of desiccating chemicals. The indicator material 120 is sensitive to moisture and is selected so that the color change occurs when the desiccant has absorbed enough moisture as to become ineffective. The label 100 is placed on the inside of the bottle C. Once the color change has occurred, a message is revealed, visible through the wall of the container, permanently indicating that the desiccant is no longer effective. The anti-counterfeiting feature 112 and the tamper-evident feature 140 guard against defeat by replacement with a look-alike or tampering.

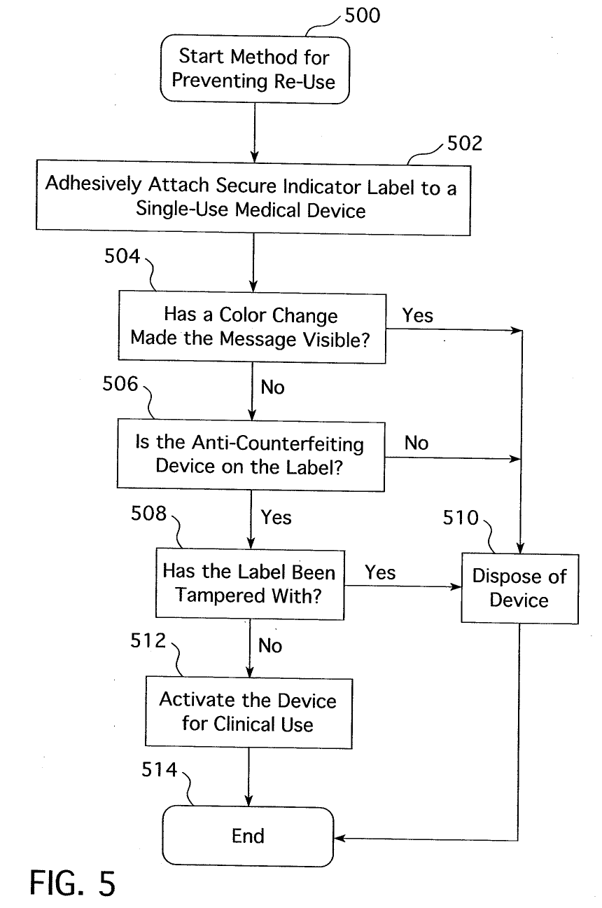

The present invention also provides methods of determining whether an article or material has been exposed to a particular environment. FIG. 5 is a flow chart of a method for reducing the likelihood of improper re-use of a single-use medical device. The method begins at 500 and comprises adhesively attaching a secure indicator label to the medical device at 502, wherein the secure indicator label comprises an indicator capable of undergoing a color change when exposed to a particular environment, anti-counterfeiting means, and tamper-evident means. A visual inspection is made at 504 to determine if a color change is observed. If a mask is used in the secure indicator label, any color change will reveal the message. If a color change is observed, the device is disposed of at 510. A visual inspection is made at 506 to determine if the anti-counterfeiting feature is visible. If it is not, then the label is a look-alike intended to deceive the user and the device is disposed of at 510. Finally, a visual inspection of the tamper-evident feature is made at 508. If the label has been tampered with, the device is disposed of at 510. If there has been no color change or tampering, and the anti-counterfeit features are visible, then activation of the device is allowed at 512 and the method terminates at 514.

It will be appreciated by those skilled in the art that changes could be made to the embodiments described above without departing from the broad inventive concept thereof. For example, it is understood that all aspects and embodiments of the present invention can be related to single-use articles, devices and methods, such as but not limited to, single-use articles, devices and methods for use in the medical field. It is understood, therefore, that this invention is not limited to the particular embodiments disclosed, but it is intended to cover modifications that are within the spirit and scope of the invention, as defined by the appended claims.

What is claimed is:

1. A label for an article, comprising an indicator capable of undergoing a color change when exposed to a particular environment and an anti-counterfeiting means and/or a tamper-evident means.

2. The label according to claim 1, wherein the anti-counterfeiting means is selected from the group consisting of a hologram, an optically variable device and an optically variable image, and wherein said anti-counterfeiting means provide optical effects.

3. The label according to claim 1, wherein the tamper-evident means is created by the incorporation of a pattern of release material between the layers of a multi-layer label, wherein such material selectively degrades the chemical bond between the layers so that the label is destroyed if an attempt is made to remove the label from the article.

4. The label according to claim 1, wherein the tamper-evident means is created by die cuts in the label that cause the label to segment if an attempt is made to peel the label off of the article.

5. The label according to claim 1, wherein the label is part of the construction of the article.

6. The label according to claim 1, wherein the environment is selected from the group consisting of moisture, steam, high temperature and a chemical.

7. The label according to claim 1, wherein the indicator is an encapsulated dye.

8. The label according to claim 1, wherein the article is a single-use device.

9. The label according to claim 1, wherein the article is a medical device.

10. The label according to claim 9, wherein the article is a single-use device.

11. The label according to claim 1, wherein the article is a container or packaging.

12. The label according to claim 1, wherein the label is a multi-layer label comprising a transparent top layer, a visually-indicating middle layer and an adhesive bottom layer.

13. The label according to claim 12, further comprising a mask positioned between the transparent top layer and the visually-indicating middle layer.

14. A method for indicating whether an article has been exposed to a particular environment, comprising:
adhesively attaching to the article a label, the label comprising an indicator capable of undergoing a color change when exposed to a particular environment and an anti-counterfeiting means and/or a tamper-evident means; and
visually examining the label for an appropriate color change.

15. The method of claim 14, wherein the article is a single-use medical device.

16. The method of claim 14, wherein the environment is selected from the group consisting of moisture, steam, high temperature and a chemical.

17. A method for indicating whether the contents of a container or package have been exposed to a particular environment, comprising:
adhesively attaching to the container or package a label according to claim 1; and
visually examining the label for an appropriate color change.

18. The method of claim 11, wherein the container is a bottle or a jar.

19. A method for reducing the likelihood of improper re-use of a single-use device, comprising:
adhesively attaching to the single-use device a label, the label comprising an indicator capable of undergoing a color change when exposed to a particular environment and an anti-counterfeiting means and/or a tamper-evident means;
visually inspecting the indicator label for indication of color change, tampering, and/or counterfeiting; and
disposing of the single-use device if the inspection indicates previous use.

20. The method of claim 19, wherein the single-use device comprises a medical device.
